(19) United States
(12) Patent Application Publication
(10) Pub. No.: US 2011/0216700 A1
(43) Pub. Date: Sep. 8, 2011

(54) METHOD AND APPARATUS FOR PERFORMING UPLINK RANDOM ACCESS IN A WIRELESS COMMUNICATION SYSTEM

(75) Inventors: Jung-Min Moon, Seoul (KR); Howon Lee, Yuseong-gu (KR); Dong-Ho Cho, Yuseong-gu (KR); Jung-Je Son, Yongin-si (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 13/040,820

(22) Filed: Mar. 4, 2011

(30) Foreign Application Priority Data
Mar. 4, 2010 (KR) 10-2010-0019594

(51) Int. Cl. H04W 74/08

(52) U.S. Cl. 370/328

(57) ABSTRACT

A method and apparatus of a base station (BS) perform uplink (UL) random access in a wireless communication system. Random access channel information is determined on each of a plurality of frames constituting a superframe, and a control message comprising the random access channel information is broadcasted. A method and apparatus of a mobile station (MS) perform UL random access in a wireless communication system. A control message comprising random access channel information is received. A frame for minimizing a collision during a contention-based random access is selected based on the random access channel information. For data to be transmitted using the selected frame, it is determined whether the information to be transmitted is an access class with equal or higher priority to a received access class comprised in the random access channel information. A contention-based random access bandwidth request is transmitted to the BS for the data to be transmitted.

### CROSS-REFERENCE TO RELATED APPLICATION(S) AND CLAIM OF PRIORITY

The present application is related to and claims the benefit under 35 U.S.C. §119 to an application filed in the Korean Intellectual Property Office on Mar. 4, 2010 and assigned Serial No. 10-2010-0019594, the contents of which are incorporated herein by reference.

### TECHNICAL FIELD OF THE INVENTION

The present invention relates to an uplink (UL) random access scheme in a wireless communication system. More particularly, the present invention relates to a method and apparatus for UL access control that provides UL transmission opportunities differentiated according to user's priority (i.e., grade or class) in a wireless communication system.

### BACKGROUND OF THE INVENTION

Broadband wireless communication systems that provide high-speed data rates are being developed in an Institute of Electrical and Electronics Engineers (IEEE)802.16 Wireless Metropolitan Access Network (WMAN) Working Group. Intensive research is being conducted to provide the IEEE 802.16 standard based on an Orthogonal Frequency Division Multiple Access (OFDMA) technology as a system applicable to a licensed bandwidth of two to eleven Giga Hertz (GHz) and an unlicensed bandwidth.

Uplink in the OFDMA based wireless system utilizes a random access scheme of a more complex structure because of a characteristic of an Orthogonal Frequency Division Multiplexing (OFDM) modulation scheme. 802.16 systems and the like apply a Code Division Multiple Access (CDMA) code scheme, reducing the possibility of collisions that may occur upon random access between Mobile Stations (MSs).

Meanwhile, in the conventional art, when each user attempts UL transmission, all MSs equally perform a random access procedure regardless of their own priorities (i.e., grades or classes). Here, the users' grades or classes are chiefly determined by the importance or the degree of urgency of data (or packets) that a user MS will transmit. In detail, users of high class refer to users with data to drop if not transmitted at the present time or data including very urgent information, and users of low class refer to users belonging to the contrary situation. An example of classification of these user classes is shown in Table 1 below.

TABLE 1

| | Service type | Priority |
|---|---|---|
| Highest class | Delay-sensitive | High |
| High class | Delay-sensitive | Low |
| Medium class | Delay-tolerant | High |
| Low class | Delay-tolerant | Low |

When the user class is classified according to Table 1 above, if all user MSs perform random access regardless of priorities, a user MS of low class may outrival other user MSs of high class and transmit UL data first.

Therefore, there is a need for a method and apparatus for performing UL random access considering priority (i.e., grade or class) of an MS in a wireless communication system.

### SUMMARY OF THE INVENTION

To address the above-discussed deficiencies of the prior art, it is a primary aspect of the present invention to solve at least the above-mentioned problems and/or disadvantages and to provide at least the advantages below. Accordingly, one aspect of the present invention is to provide a method and apparatus for performing uplink (UL) random access in a wireless communication system.

Another aspect of the present invention is to provide a method and apparatus for, upon UL random access, minimizing the probability of collision with other Mobile Stations (MSs) in a wireless communication system.

Another aspect of the present invention is to provide a method and apparatus for UL access control providing UL transmission opportunities differentiated according to user's class in a wireless communication system.

The above aspects are achieved by providing a method and apparatus for performing uplink random access in a wireless communication system.

According to one aspect of the present invention, a method of base station (BS) operation for uplink (UL) random access in a wireless communication system is provided. The method includes determining random access channel information on each of a plurality of frames constituting a superframe. A control message comprising the random access channel information is broadcasted.

According to another aspect of the present invention, a method of mobile station (MS) operation for uplink (UL) random access in a wireless communication system is provided. The method includes receiving a control message comprising random access channel information from a base station (BS). A frame minimizing a collision during a contention-based random access is selected based on the random access channel information. It is determined whether data to be transmitted using the selected frame is an access class with equal or higher priority to an access class comprised in the random access channel info nation. A contention-based random access bandwidth request is transmitted to the BS for the data to be transmitted.

According to another aspect of the present invention, a base station (BS) apparatus for uplink (UL) random access in a wireless communication system is provided. The apparatus includes a controller and a transmitter. The controller determines random access channel information on each of a plurality of frames constituting a superframe. The transmitter broadcasts a control message comprising the random access channel information.

According to yet another aspect of the present invention, a mobile station (MS) apparatus for uplink (UL) random access in a wireless communication system is provided. The apparatus includes a receiver, a controller, and a transmitter. The receiver receives a control message comprising random access channel information from a base station (BS). The controller selects a frame minimizing a collision during a contention-based random access based on the random access channel information and, for data to be transmitted using the selected frame, identifies whether it is an access class with equal or higher priority to an access class comprised in the random access channel information. The transmitter sends to the BS a contention based random access bandwidth request, for the data to be transmitted.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of certain embodiments of the present invention will be more apparent from the following description taken in conjunction with the accompanying drawings in which:

FIG. 1 illustrates a Base Station (BS) operation for performing uplink (UL) random access in a broadband wireless communication system according to an embodiment of the present invention;

FIG. 2 illustrates a Mobile Station (MS) operation for performing UL random access in a broadband wireless communication system according to an embodiment of the present invention;

FIGS. 3A-3C illustrate an example of determining an access class and a minimum random access priority value for a random access slot according to an embodiment of the present invention;

FIG. 4 illustrates an example of determining an access class and a minimum random access priority value for a random access slot in a superframe structure according to an embodiment of the present invention;

FIG. 5 illustrates an example of determining an access class and a minimum random access priority value for a random access slot in a superframe structure according to an embodiment of the present invention; and

FIG. 6 illustrates an apparatus for performing UL random access in a broadband wireless communication system according to an embodiment of the present invention.

### DETAILED DESCRIPTION OF THE INVENTION

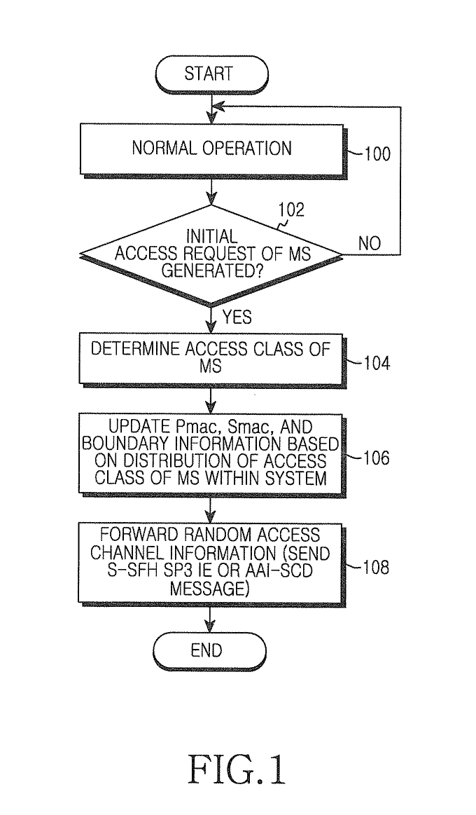

FIGS. 1 through 6, discussed below, and the various embodiments used to describe the principles of the present disclosure in this patent document are by way of illustration only and should not be construed in any way to limit the scope of the disclosure.

Preferred embodiments of the present invention will be described herein below with reference to the accompanying drawings. In the following description, well-known functions or constructions are not described in detail as they would obscure the invention in unnecessary detail. Terms described below, which are defined considering functions in the present invention, may be different depending on user and operator's intent or practice. Therefore, the terms should be defined on the basis of the disclosure throughout this specification.

Below, embodiments of the present invention provide a method and apparatus for performing uplink (UL) random access in a wireless communication system. Particularly, the embodiments of the present invention propose an efficient random access scheme based on priority (i.e., random access priority or service class priority) in a next generation wireless communication system, including an Institute of Electrical and Electronics Engineers (IEEE) 802.16m system. For example, a Base Station (BS) broadcasts a minimum random access priority value by frame or by subframe to a Mobile Station (MS) through a superframe header or a Medium Access Control (MAC) control message and such, considering the distribution of random access priorities of user MSs. Based on this information, the user MSs select a frame or subframe to attempt random access by considering their own priorities, and perform the random access process. Particularly, user MSs of high priority may increase their own random access success probabilities by selecting frames (or subframes) that they themselves will access, using broadcasting information such that a collision probability is minimized.

FIG. 1 illustrates a BS process for performing UL random access in a broadband wireless communication system according to an embodiment of the present invention.

Referring to FIG. 1, in block 100, a BS performs normal operation, and broadcasts random access channel information in every predetermined superframe. An IEEE 802.16m system uses a message such as a Secondary-SuperFrame Header SubPacket3 Information Element (S-SFH SP3 IE), an Advanced Air Interface—System Configuration Descriptor (AAI-SCD), and such.

If an initial access request of an MS is generated in block 102, the BS proceeds to block 104 and determines an access class of the MS. For example, when an access class of an MS is previously determined by a payment system to which a user subscribes and such, when the MS makes an initial access request, the BS determines the access class of the MS. When an access class of an MS is determined by the type of service that a user uses, when the MS makes an initial access request, the BS allocates an arbitrary or lowest access class and, when the MS makes an actual service request, the BS assigns an access class that is suitable to the service type to the MS, thus determining the access class of the MS.

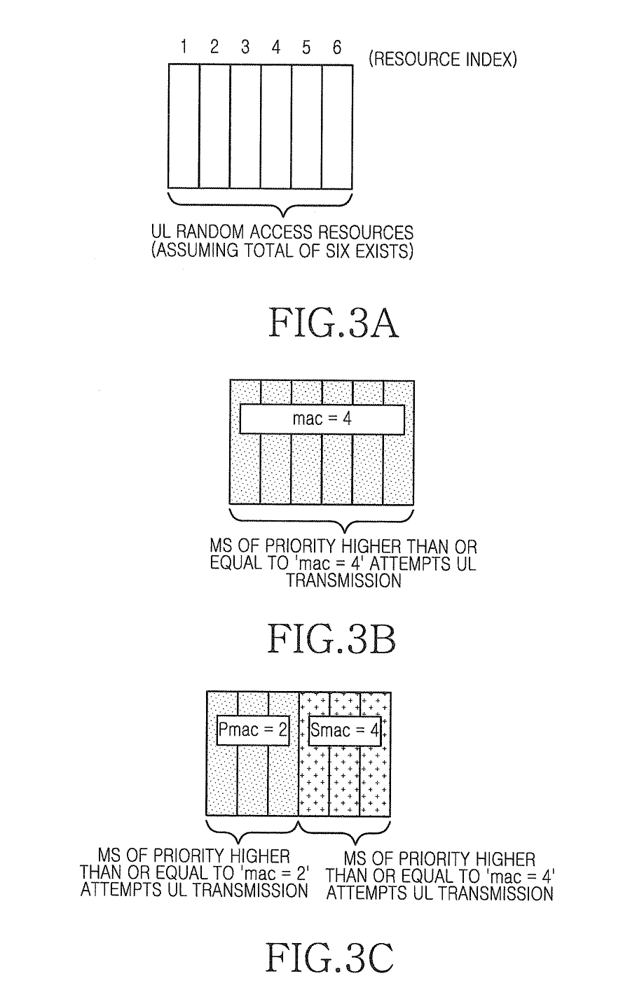

A method for determining an access class and a minimum random access priority value within the access class for a random access slot by frame or by subframe is described in detail with reference to FIGS. 3 to 5 below.

In block 106, based on the determined access class of the MS, the BS identifies an access class distribution state for all MSs existing within a cell area and, based on the access class distribution state for the MSs, the BS updates random access channel information on all the MSs existing within the cell area. The random access channel information controls a Primary minimum access class (Pmac), a Secondary minimum access class (Smac), and a boundary value (i.e., a resource size for Pmac) for distinguishing the Pmac and the Smac.

In block 108, the BS broadcasts the updated random access channel information through an S-SFH SP3 IE or AAI-SCD message.

Table 2 below shows four scenarios in which the BS broadcasts the random access channel information.

TABLE 2

| Sce- | | |
|---|---|---|
| nario | Information | Description |
| 1 | (1) Primary mac | (a) MS of priority higher than or equal |
| | (2) Secondary mac | to Pmac may attempt UL transmission in |
| | (3) Resource size | resources for Pmac |
| | for Pmac | (b) MS of priority higher than or equal |
| | | to Smac may attempt UL transmission in |
| | | the remaining resources |
| 2 | (1) Primary mac | (a) MS of priority higher than or equal |
| | (2) Resource size | to Pmac may attempt UL transmission in |
| | for Pmac | resources for Pmac |
| | | (b) all MSs may attempt UL transmission |
| | | in the remaining resources |
| 3 | (1) Primary mac | (a) MS of priority higher than or equal |
| | | to Pmac may attempt UL transmission in |
| | | all resources |
| 4 | (1) None | (a) all MSs may attempt UL transmission |
| | | in all resources |

Referring to Table 2, in Scenario 1, a BS broadcasts all of a Pmac, an Smac, and a resource size for the Pmac. In this situation, an MS of priority higher than or equal to the Pmac attempts UL transmission in resources for the Pmac, and an MS of priority higher than or equal to the Smac attempts UL transmission in the remaining resources. In Scenario 2, a BS broadcasts a Pmac and a resource size for the Pmac based on an overhead. In this situation, an MS of priority higher than or equal to the Pmac attempts UL transmission in resources for the Pmac, and all MSs attempt UL transmission in the remaining resources. In Scenario 3, a BS broadcasts only a Pmac. In this situation, an MS of priority higher than or equal to the Pmac attempts UL transmission in all the resources. In Scenario 4, a BS broadcasts no separate random access channel information. In this situation, all MSs attempt UL transmission in all the resources.

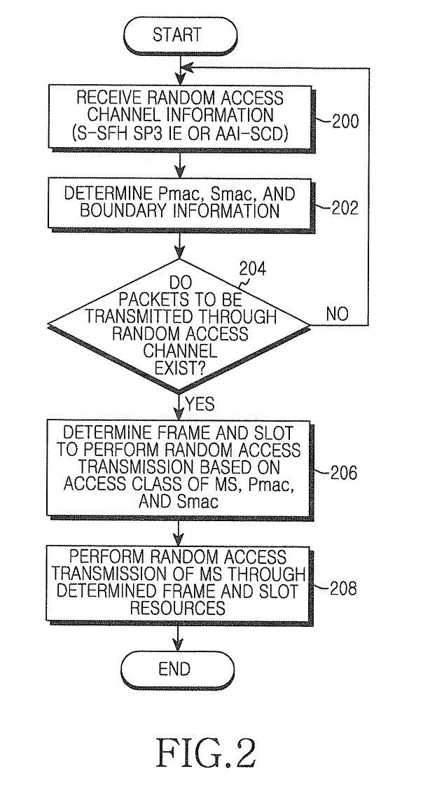

FIG. 2 illustrates an MS operation for performing UL random access in a broadband wireless communication system according to an embodiment of the present invention.

Referring to FIG. 2, in block 200, an MS receives UL random access channel information (i.e., a Pmac, an Smac, and a resource size for Pmac) in a control message that a BS broadcasts. In an IEEE 802.16m system, the control message is an SFH-SP3, an AAI-SCD and such.

In block 202, the MS determines a random access slot that is accessible with its own current access class, based on the received random access channel information. In other words, the MS may determine its own random access slot in a random access channel by identifying an access class of a random access slot determined by a BS and comparing the identified access class with its own access class.

When it is determined in block 204 that there are packets (e.g., packets for bandwidth request or packets for ranging request) to be transmitted through a random access channel, the MS proceeds to block 206 and determines in what random access resource (or random access slot) the MS will perform random access transmission, based on the received random access channel information (i.e., Pmac and Smac information).

In block 208, the MS performs the random access transmission through the determined frame and random access slot.

FIGS. 3A-3C illustrate an example of determining an access class and a minimum random access priority value for a random access slot according to an embodiment of the present invention. Here, it is assumed that one random access channel is composed of a plurality of random access slots.

In FIG. 3A, one random access channel is composed of six random access slots. In FIG. 3B, when ‘mac=4’ is set for all random access slots, MSs of priority higher than or equal to ‘mac=4’ attempt random access to six random access slots. But there is a disadvantage in that a random access success probability of an MS of higher priority among the MSs of priority higher than or equal to ‘mac=4’ may not be guaranteed because the MS of higher priority contends with an MS of relatively low priority in the same state. In other words, although the MSs belong to the same access class, their priorities may be different within the same access class.

FIG. 3C bisects a plurality of random access slots existing in a given random access channel and applies different minimum random access priorities (i.e., macs) to the plurality of random access slots. In other words, among the six random access slots, three are assigned ‘Pmac=2’, and the remaining three are assigned ‘Smac=4’. Only MSs of priority higher than or equal to ‘Pmac=2’ may perform random access to the left three random access slots, and only MSs of priority higher than or equal to ‘Smac=4’ may perform random access to the right three random access slots. An embodiment of the present invention prevents an MS of high priority from carrying out random access contention with an MS of low priority by differently assigning random access slots to which the MSs of high priority and the MSs of low priority may perform random access. Also, the embodiment of the present invention may control the whole random access success probability by adaptively dividing random access slots according to the number of MSs of high priority existing within a system, the number of MSs of low priority, and such.

In this situation, a BS should broadcast information such as Pmac information, Smac information, and boundary information between a Pmac and an Smac in a random access slot. Here, the boundary information between the Pmac and the Smac may be an overhead and hence, the BS may use a fixed boundary between the Pmac and the Smac. Consequently, the BS may omit the boundary information between the Pmac and the Smac. Also, when the BS sets a value of Smac to a minimum priority value in a random access slot, Smac information may be omitted as well. When omitting the two pieces of information as described above, the BS may broadcast only Pmac information by frame or by subframe.

Also, when there are many priorities, the BS may control even the success probabilities of MSs of medium priority by adding a value of Smac.

The BS broadcasts minimum random access priority values determined by considering the distribution of priorities of users to MSs through a superframe subpacket (e.g., S-SFH SP3 IE), MAC control message (e.g., AAI-SCD), or a superframe header. The information broadcasted by the BS is maintained until the minimum random access priority information broadcasting transmission time of a next BS.

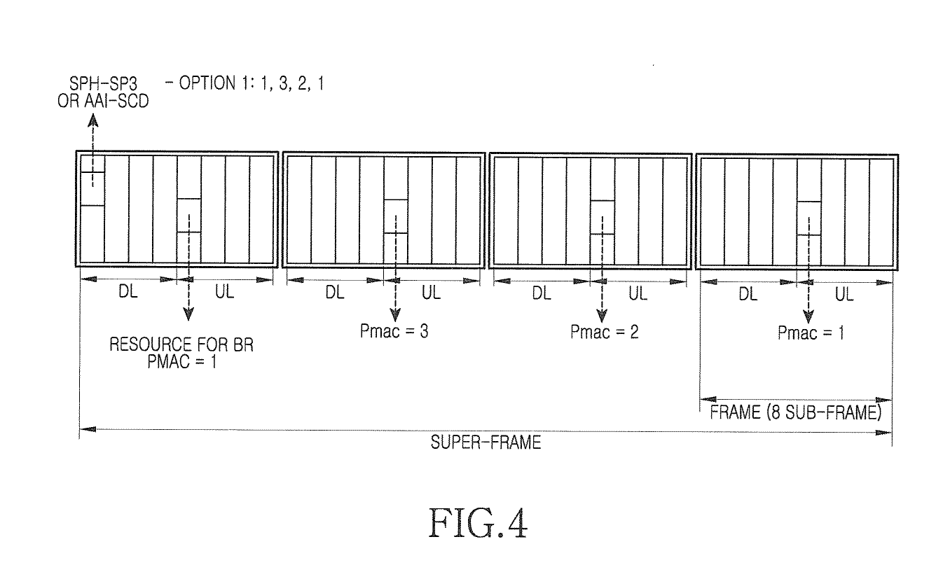

FIG. 4 illustrates an example of determining an access class and a minimum random access priority value for a random access slot in a superframe structure according to an embodiment of the present invention.

Referring to FIG. 4, a superframe (e.g., 20 ms) of an IEEE 802.16m system is composed of four frames (e.g., 5 ms), and each frame is composed of eight subframes.

FIG. 4 illustrates an example for a situation in which a random access slot exists only in a first subframe of each frame. When random access slots exist in all subframes of a frame, extension is possible in the same method. Also, in a random access slot within a subframe, a BS may distinguish priorities only on a per-frame basis instead of not dividing a random access region. In this situation, by broadcasting random access priority information in a first frame within a superframe, users of high priority may selectively perform random access, thus being capable of reducing a collision probability.

For example, a Pmac value (i.e., 1, 3, 2, 1) by frame within a subpacket (e.g., S-SFH SP3 IE), or MAC control message (e.g., AAI-SCD), or a superframe header is transmitted. Consequently, an MS of priority higher than or equal to ‘Pmac=1’ attempts random access to a random access slot within a first frame of a superframe, and an MS of priority higher than or equal to ‘Pmac=3’ attempts random access to a random access slot within a second frame of the superframe, an MS of priority higher than or equal to ‘Pmac=2’ attempts random access to a random access slot within a third frame of the superframe, and an MS of priority higher than or equal to ‘Pmac=1’ attempts random access to a random access slot within a fourth frame of the superframe.

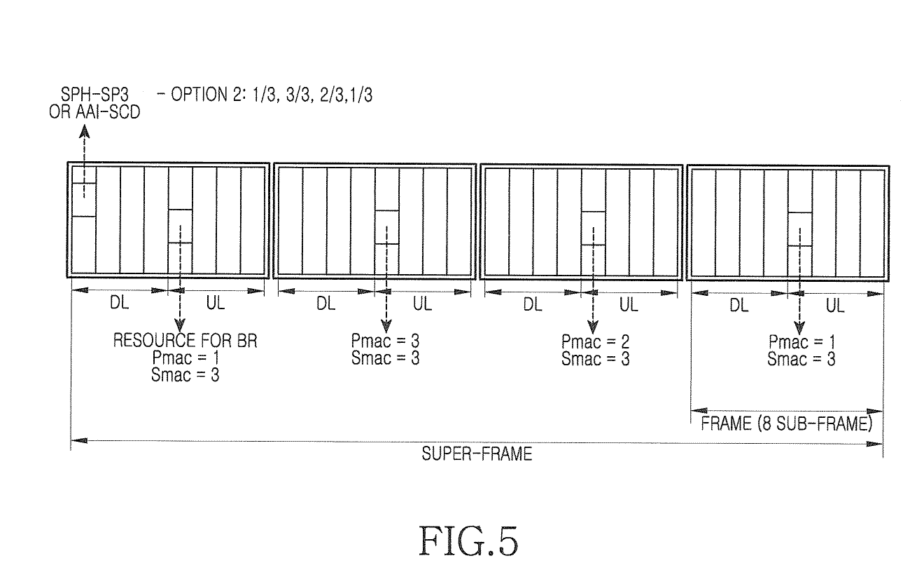

FIG. 5 illustrates an example of determining an access class and a minimum random access priority value for a random access slot in a superframe structure according to an embodiment of the present invention.

Similar to FIG. 4, FIG. 5 is an example for a situation in which a random access slot exists only in a first subframe of a frame. When random access slots exist in all subframes, extension is possible in the same method.

However, unlike FIG. 4, FIG. 5 illustrates an embodiment in which a random access region is divided into a Pmac and an Smac within a subframe. In this situation, unlike FIG. 4 failing to perform random access due to a minimum priority restriction in a corresponding frame, users may perform random access using a random access slot split for low priority, thereby reducing an unnecessary delay. In other words, in FIG. 5, all MSs of high priority, middle priority, and low priority may perform random access in every frame according to setting.

A BS may broadcast random access priority information in a first subframe within a superframe, so user MSs of high priority may selectively perform random access. For example, the BS sets and broadcasts ‘Pmac/Smac=1/3, 3/3, 2/3, 1/3’ as a Pmac value and an Smac value of random access resources existing within a corresponding superframe in order of frame within a superframe subpacket (e.g., S-SFH SP3 IE), MAC control message (e.g., AAI-SCD), or a superframe header. Consequently, an MS of priority higher than or equal to ‘Pmac=1’ attempts random access in some of the random access resources of a first frame of a corresponding superframe, and an MS of priority higher than or equal to ‘Smac=3’ attempts random access in the remaining of the random access resources of the first frame. An MS of priority higher than or equal to ‘Pmac=3’ may attempt random access in some of random access resources of a second frame of the corresponding superframe, and an MS of priority higher than or equal to ‘Smac=3’ may attempt random access in the remaining of the random access resources of the second frame. An MS of priority higher than or equal to ‘Pmac=2’ may attempt random access in some of random access resources of a third frame of the corresponding superframe, and an MS of priority higher than or equal to ‘Smac=3’ may attempt random access in the remaining of the random access resources of the third frame. An MS of priority higher than or equal to ‘Pmac=1’ may attempt random access in some of random access resources of a fourth frame of the corresponding superframe, and an MS of priority higher than or equal to ‘Smac=3’ may attempt random access in the remaining of the random access resources of the fourth frame.

In FIG. 5, along with Pmac and Smac information, resource partition boundary information should be forwarded. The resource partition boundary information represents a boundary between a resource region that a user of priority higher than or equal to a Pmac uses and a resource region that a user of priority higher than or equal to an Smac uses. Like the Pmac and Smac information, the resource partition boundary information is forwarded through a superframe subpacket (e.g., S-SFH SP3 IE), MAC control message (e.g., AAI-SDC), or a superframe header. At this time, a resource partition boundary value determination factor may be the distribution of priority of a user existing within a current system and such. A scheme of indexing a resource partition boundary is given as follows. When one random access channel is composed of six random access slots and the six random access slots are each indexed by ‘1’ to ‘6’ according to FIG. 3A, the index of the random access slot may be defined as a resource partition boundary value. Consequently, users of priority higher than or equal to a Pmac attempt random access from a random access slot ‘1’ to a random access slot corresponding to the resource partition boundary value, and users of priorities higher than or equal to an Smac attempt random access from a (resource partition boundary+1) to the last random access slot index. That is, in FIG. 3C, the resource boundary partition value is set to ‘3’. In this situation, user MSs of priority higher than or equal to a Pmac have random access to a random access slot ‘1’ to a random access slot ‘3’, and user MSs of priority higher than or equal to an Smac have random access to a random access slot ‘4’ to a random access slot ‘6’.

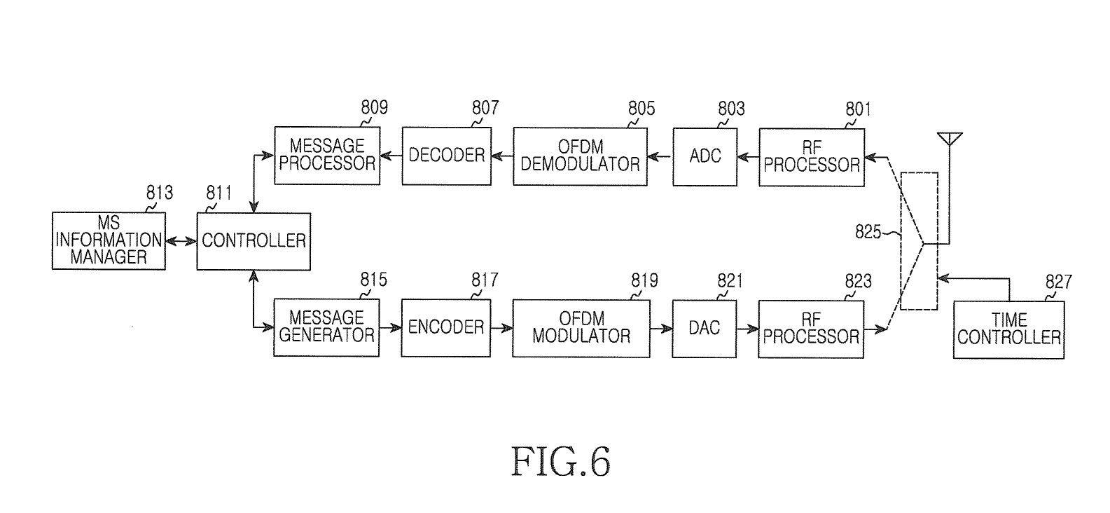

FIG. 6 illustrates an apparatus (BS or MS) for performing UL random access in a broadband wireless communication system according to an embodiment of the present invention.

Referring to FIG. 6, the BS or MS includes an RF processor 801, an Analog to Digital Converter (ADC) 803, an Orthogonal Frequency Division Multiplexing (OFDM) demodulator 805, a decoder 807, a message processor 809, a controller 811, an MS information manager 813, a message generator 815, an encoder 817, an OFDM modulator 819, a Digital to Analog Converter (DAC) 821, an RF processor 823, a switch 825, and a time controller 827.

The time controller 827 controls a switching operation of the switch 825 based on time synchronization. For example, while receiving a signal, the time controller 827 controls the switch 825 to connect the RF processor 801 of a receive end with an antenna and, wjo;e transmitting a signal, the time controller 827 controls the switch 825 to connect the RF processor 823 of a transmit end with the antenna.

During reception, the RF processor 801 converts a Radio Frequency (RF) signal received through the antenna into a baseband analog signal. The ADC 803 converts the analog signal from the RF processor 801 into sample data. The OFDM demodulator 805 processes, by Fast Fourier Transform (FFT), the sample data output from the ADC 803 and converts the sample data into frequency domain data, selects data of subcarriers intended for actual reception from the frequency domain data, and outputs the selected data. The decoder 807 demodulates and decodes the data from the OFDM demodulator 805 according to a predefined modulation level (i.e., a Modulation and Coding Scheme (MCS) level).

The message processor 809 analyzes a control message input from the decoder 807 and provides the result to the controller 811. For example, the message processor 809 extracts random access channel information (i.e., a Pmac, an Smac, and a resource size for Pmac) received from a BS and provides the extracted information to the controller 811.

The controller 811 performs a corresponding process for information from the message processor 809, generates information to be transmitted, and provides the information to the message generator 815. In addition to the present invention, the controller 811 controls a UL random access procedure.

The message generator 815 generates a message with various types of information (e.g., random access channel information) provided from the controller 811 and outputs the generated message to the encoder 817 of a physical layer. The encoder 817 encodes and modulates data from the message generator 815 according to a predefined modulation level (i.e., an MCS level). The OFDM modulator 819 processes, by Inverse Fast Fourier Transform (IFFT), the data from the encoder 817 and outputs sample data (i.e., OFDM symbols). The DAC 821 converts the sample data into an analog signal. The RF processor 823 converts the analog signal from the DAC 821 into an RF signal and transmits the RF signal through the antenna.

The MS information manager 813 determines and manages an access class of an MS and a minimum random access priority value within the access class during an initial operation or service initiation operation with the MS.

During a BS operation, the MS information manager 813 determines the random access priority of an MS in an initialization process or service initiation process of the MS. In other words, during the initialization process or service initiation process, the BS and the MS determine random access priority through negotiation. Through this process, the BS may determine the distribution of random access priorities of all the MSs that belong to the BS. And, the MS information manager 813 determines a minimum random access priority value for a random access slot by frame or by subframe within a superframe, based on the distribution of random access priorities of all the MSs. A method of determining the minimum random access priority value for the random access slot by frame or by subframe is referred to FIGS. 3A to 5. The controller 811 broadcasts minimum random access priority values determined by considering, the distribution of priorities of user MSs, to the MSs through a superframe subpacket (e.g., S-SFH SP3 IE), MAC control message (e.g., AAI-SCD), or a superframe header. The information broadcasted by the BS is maintained until a next minimum random access priority information broadcasting transmission time. While gaining initial access to a system and not receiving minimum random access priority information, MSs initially perform random access with the highest priority.

During an MS operation, the controller 811 may receive control information associated with a minimum random access priority value from a BS and select a random access slot that it will perform, based on the control information. Particularly, according to the present invention, MSs of high priority select a random access slot of high minimum random access priority that is usable when there is room for a transmission delay of some extent, such that the MS may increase a random access success probability. Also, by broadcasting minimum random access priority and dividing a random access region, the random access success probabilities of MSs of high priority are improved compared to an existing scheme.

As described above, embodiments of the present invention have an advantage of, by initially informing class information of a user whose UL access attempt is possible in each random access slot, being capable of ensuring the UL transmission opportunities of an MS of high class, and maintaining a collision probability for all the MSs. Also, the embodiments of the present invention may reduce a phenomenon in which MSs of high class collide with MSs of low class.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of operating a base station (BS) for uplink (UL) random access in a wireless communication system, the method comprising:
determining random access channel information on each of a plurality of frames constituting a superframe; and
broadcasting a control message comprising the random access channel information.

2. The method of claim 1, wherein the random access channel information comprises at least one of information for determining at least one access class for minimizing a collision during a contention-based random access and random slot durations corresponding to the at least one access class.

3. The method of claim 2, wherein the access class is assigned to a mobile station (MS) during one of a service flow establishment and a modification.

4. The method of claim 1, wherein the control message is an Advanced Air Interface—System Configuration Descriptor (AAI-SCD) message.

5. The method of claim 1, wherein the random access channel information is determined based on a distribution of priority of a user MS.

6. A method of operating a mobile station (MS) for uplink (UL) random access in a wireless communication system, the method comprising:
receiving a control message comprising random access channel information from a base station (BS);
selecting a frame for minimizing a collision during a contention-based random access, based on the random access channel information;
determining whether data to be transmitted using the selected frame is an access class with at least an equal priority to a received access class comprised in the random access channel information; and
transmitting to the BS a contention-based random access bandwidth request for the data to be transmitted.

7. The method of claim 6, wherein the random access channel information comprises at least one of information for determining at least one access class for minimizing a collision during a contention-based random access and random slot durations corresponding to the at least one access class.

8. The method of claim 7, wherein the access class is assigned to an MS during one of a service flow establishment and a modification.

9. The method of claim 6, wherein the control message is an Advanced Air Interface—System Configuration Descriptor (AAI-SCD) message.

10. The method of claim 6, wherein the random access channel information is determined based on a distribution of priority of a user MS.

11. The method of claim 6, further comprising waiting until the access class of the information to be transmitted receives random access channel information comprising a received access class with low priority.

12. A base station (BS) apparatus for uplink (UL) random access in a wireless communication system, the apparatus comprising:
a controller configured to determine random access channel information on each of a plurality of frames constituting a superframe; and
a transmitter configured to broadcast a control message comprising the random access channel information.

13. The apparatus of claim 12, wherein the random access channel information comprises at least one of information for determining at least one access class for minimizing a collision during a contention-based random access and random slot durations corresponding to the at least one access class.

14. The apparatus of claim 13, wherein the access class is assigned to a mobile station (MS) during one of a service flow establishment and a modification.

15. The apparatus of claim 12, wherein the control message is an Advanced Air Interface—System Configuration Descriptor (AAI-SCD) message.

16. The apparatus of claim 14, wherein the controller is further configured to determine the random access channel information based on a distribution of priority of a user MS.

17. A mobile station (MS) apparatus for uplink (UL) random access in a wireless communication system, the apparatus comprising:
a receiver configured to receive a control message comprising random access channel information from a base station (BS);
a controller configured to select a frame for minimizing a collision during a contention-based random access based on the random access channel information and, determine whether data to be transmitted using the selected frame is an access class with at least an equal priority to a received access class comprised in the random access channel information; and
a transmitter configured to transmit to the BS a contention-based random access bandwidth request, for the data to be transmitted.

18. The apparatus of claim 17, wherein the random access channel information comprises at least one of information for determining at least one access class for minimizing a collision during a contention-based random access and random slot durations corresponding to the at least on access class.

19. The apparatus of claim 18, wherein the access class is assigned to an MS during one of a service flow establishment and a modification.

20. The apparatus of claim 17, wherein the control message is an Advanced Air Interface—System Configuration Descriptor (AAI-SCD) message.

21. The apparatus of claim 17, wherein the random access channel information is determined based on a distribution of priority of a user MS.

22. The apparatus of claim 17, wherein the controller is further configured to wait until the access class of the information to be transmitted receives random access channel information comprising a received access class with low priority.
